(19) United States
(12) Patent Application Publication
(10) Pub. No.: US 2019/0135475 A1
(43) Pub. Date: May 9, 2019

(54) CONTAINER HANDLING MACHINE HAVING A ROTARY PLATE DIRECT DRIVE

(71) Applicants: KRONES AG, Neutraubling (DE); BAUMÜLLER HOLDING GMBH & CO. KG, Nürnberg (DE)

(72) Inventors: Joerg TRIEBEL, Neutraubling (DE); Dieter HAFNER, Neutraubling (DE); Soeren MEISSNER, Neutraubling (DE); Jürgen PFLÜGER, Nörten-Hardenberg (DE)

(21) Appl. No.: 16/098,636

(22) PCT Filed: May 3, 2017
(86) PCT No.: PCT/EP2017/060485

§ 371 Date: Nov. 2, 2018

(30) Foreign Application Priority Data
May 3, 2016 (DE) 10 2016 207 583.7

(51) Int. Cl. B65C 9/04; B65C 9/06

(52) U.S. Cl. CPC B65C 9/04; F16J 15/3456; B65C 9/067

(57) ABSTRACT

The invention relates to a container handling machine comprising at least one container receiver having a rotary plate and comprising a rotary plate direct drive for driving the rotary plate, wherein the rotary plate direct drive comprises a motor which is designed with a stator, a rotor, a shaft joined to the rotor for transmitting a drive torque to the rotary plate and with a shaft sealing system for sealing the shaft, wherein the shaft sealing system comprises a running surface and at least one counteractive sealing lip, wherein the shaft is designed as one piece at least from the rotor and through the shaft sealing system, and in that the running surface is joined to the shaft for conjoint rotation and in a manner such that it is decoupled from the transmission of the drive torque.

The invention relates to a container-handling machine with the features of the preamble of claim 1. A container-handling machine can, for example, be designed as a labelling machine with labelling stations, a transport carousel and circumferentially arranged container holders, whereby the containers are first picked up in the container holders and then conveyed through the labelling stations for labelling. During conveyance, the container holder is swiveled synchronously while applying the label, such that the label is applied as evenly as possible to the container circumference. For this purpose, the container holders each have a rotary plate, which can be rotated with a rotary plate-direct drive. This means that each rotary plate can be controlled individually by a machine controller for the labelling process and can therefore be adapted particularly flexibly to different label and container types. A shaft-sealing system, which protects the interior of the motor from dirt, is used to protect the direct drive of the rotary plate from dirt.

For example, EP 1,596,488 A2 discloses a drive motor for the bottle turntable of a rotary labeller, in which the torque is transmitted from the drive shaft to the [bottle] turntable via connecting elements. One of the connecting elements is mounted as a drive element in a bearing plate with ball bearings and sealed against dirt with sealing elements.

The two-piece structure of the shaft towards the rotary plate, consisting of the drive shaft and the drive element, is normally used for manufacturing the drive element from a harder material than the drive shaft, so that particularly low wear occurs with regard to the sealing elements.

The disadvantage here is that production is comparatively expensive, and a correspondingly large installation space is required with regard to storage.

The objective of this invention is therefore to provide a container-handling machine with a rotary plate-direct drive to drive the rotary plate, which is less expensive to manufacture and requires less installation space.

To solve this problem, the invention provides a container-handling machine with the features of claim 1. Advantageous embodiments are specified in the sub-claims.

As the shaft is designed in one piece from the rotor and through the shaft-sealing system, the diameter of the shaft can be smaller than in a two-piece arrangement. As a result, the required installation space and thus material can be saved with regard to the bearing plate.

The fact that the running surface is connected to the shaft in such a way that it rotates with the drive torque transmission in a decoupled manner from the drive torque transmission means that the shaft-sealing system can be optimized, in particular with regard to the sealing effect and low wear of the shaft-sealing system. The shaft can be designed to be particularly stable for the transmission of the drive torque. Accordingly, the design and material of the running surface can be selected independently of the shaft. This allows the shaft-sealing system to be designed more easily and thus more cost-effectively.

The container-handling machine, for example, a labelling machine, can comprise a transport carousel with circumferentially arranged container holders, each with a rotary plate and a rotary plate-direct drive. The transport carousel of the container-handling machine can be rotated around a vertical axis by means of a drive. In this context, “vertical” can mean that this is the direction orientated towards the center of the earth. The container-handling machine can be placed in a container-manufacturing and/or beverage-processing plant. The container-handling machine can be arranged upstream or downstream of a filling line for filling a product into the containers. The device may also be arranged downstream of a stretch blow-molding machine for plastic bottles. The container-handling machine can be a labelling and/or printing machine for containers. Each container holder can comprise the rotary plate and the rotary direct drive with the shaft-sealing system.

The at least one container holder can be provided for transporting the containers. The container holder can also include a centring bell, holding clamps, or the like, for positioning a container in the holder. The rotary plate direct drive can be designed to rotate and/or swivel the rotary plate.

The containers to be handled by the container-handling machine can be intended for containing beverages, hygiene articles, pastes, chemical, biological and/or pharmaceutical products. The containers can be plastic bottles, glass bottles, cans and/or tubes. The plastic containers can in particular be PET, PEN, HD-PE or PP containers. They can also be biodegradable containers having a main component consisting of renewable raw materials, such as sugar cane, wheat or corn.

The shaft of the rotary plate-direct drive can be arranged vertically. The motor can be a positively variable electric motor, preferably a servomotor or a torque motor. Any type of electric motor (e.g. a DC, asynchronous or synchronous motor), which is operated with a closed control circuit, is conceivable. A stepper motor with or without a closed control circuit would also be conceivable. The motor can comprise a housing in which the stator, the rotor, the shaft and/or the shaft-sealing system are arranged. The shaft of the motor can be connected from the shaft sealing system directly to the rotary plate or via one or more connecting elements. The rotary plate can be arranged vertically above the rotary plate-direct drive.

A bearing plate can be designed to support the shaft. The bearing plate can be part of the motor housing, preferably part of a vertical front side of the rotary plate-disk drive. The shaft can be mounted in the motor housing rotatably via one, two or more bearings, preferably around a drive shaft. At least one of the bearings can be arranged in the bearing plate. One or more bearings can be constructed independently of each other as rolling bearings, preferably as ball, cylindrical roller or tapered roller bearings.

The fact that the shaft-sealing system is “suitable for sealing the shaft” can mean that an interior of the motor with the rotor and stator is sealed off from an external environment. Preferably, the shaft-sealing system serves to seal the interior of the motor towards the rotary plate. The shaft-sealing system can be arranged on the outer front side of the rotary plate-direct drive. Preferably, the bearing plate and/or the motor housing can be designed to accommodate at least one sealing lip. In the shaft-sealing system, at least one sealing lip can be non-rotatably connected (i.e. without relative movement) to the bearing plate or motor housing and act against the running surface connected to the shaft in rotation. Thus, the running surface moves with the shaft and forms a friction partner for the sealing lip, which is stationary to the motor housing. The sealing lip can be part of a sealing cartridge, which is designed to be replaceable for maintenance. At least one sealing lip may be at least partially made of a flexible material, such as rubber, silicone, or the like. A grease reservoir can be provided between at least two sealing lips. The running surface may be at least partially made of metal, for example steel, preferably hardened steel. Other materials, such as ceramics or brass can also be used as running surfaces. It is conceivable that the shaft-sealing system comprises two or more sealing lips, which act against the running surface.

The shaft-sealing system may comprise a circular disk-shaped element with the running surface and a feedthrough surrounding the shaft, wherein the circular disk-shaped element forms the connection, which is decoupled from the drive torque transmission, between the shaft and the running surface. Since no drive torque is transmitted with the circular disk-shaped element, the shaft can be designed particularly for transmitting the drive torque to the rotary disk, and the circular disk-shaped element particularly for the sealing effect. As a result, the shaft can be made of a softer material, since it no longer comes into contact with the sealing lip and is therefore not subject to wear. Consequently, the one-piece shaft can be manufactured more easily. On the other hand, the circular disk-shaped element intended for providing the sealing effect can be made of a material particularly suitable for this purpose, such as a hardened metal. The hardened metal can be a stainless steel, which has a hardness of, for example, 55-58 HRC and is preferably ground without twisting. As the material for the circular disk-shaped element, 1.4034 (short name: X46Cr13), for example, or a comparable material can be used. The running surface can exhibit a surface roughness of Ra=0.2 to 0.8 μm, Rz=1.0 to 4.0 μm and Rmax. 6.3 μm. This prevents high wear due to the sealing lip acting against the running surface, and the maintenance interval can be increased. Further costs can thus be saved when operating the rotary plate-direct drive. In addition, the circular disk-shaped element can also be designed compactly with regard to installation space, as it is not subject to fatigue due to the transmission of the drive torque. The feedthrough of the circular disk-shaped element can be a bore, which forms a mating surface for the shaft. In other words, the circular disk-shaped element can be rotationally connected to the shaft via the feedthrough. It is conceivable that the feedthrough is designed as a clamping or fit, preferably as a press fit relative to the shaft. In this context, the fact that the element is circular disk-shaped may mean that in the area of the running surface, it is an essentially disk-shaped arrangement with a circular outer edge that is concentric to the feedthrough. Preferably, the circular disk-shaped element can be designed to be replaceable for maintenance or in case of wear.

The shaft can be rotatably mounted with at least one bearing between the rotor and the rotary plate, whereby the circular disk-shaped element is decoupled from the bearing effect of the bearing. In other words, the circular disk-shaped element can be attached to the shaft separately from the bearing effect of the bearing. As a result, the circular disk-shaped element can be simpler and thus cheaper to construct. For example, the bearing, with which the shaft is directly supported, can be arranged in the bearing plate towards the rotor. Furthermore, the circular disk-shaped element can be arranged between the bearing and the rotary disk on the shaft.

The running surface can be formed on a flat side of the circular disk-shaped element facing away from the rotary plate, whereby the at least one sealing lip is designed as an axial shaft seal. This enables the shaft-sealing system to deflect runoff dirt particularly well, as it first reaches the top, and thus the side of the circular disk-shaped element facing the rotary disk. The dirt is then diverted outwards by the rotation of the rotary plate and only very rarely reaches the sealing lip area. In other words, the flat side of the circular disk-shaped element facing away from the rotary disk can be an underside, against which the sealing lip acts. In this context, the “axial shaft sealing ring” can mean that there is at least one sealing lip, which essentially acts in the axial direction to the drive shaft against the running surface.

It is also conceivable that these are two sealing lips, which act as a Y-arrangement against the running surface of the circular disk-shaped element. This results in a particularly good sealing effect. The Y-arrangement of the sealing lip can have a further internal sealing lip and a grease reservoir.

The shaft-sealing system can comprise a special bearing, to which at least one sealing lip is attached, preferably injection-molded. This allows the shaft-sealing system to be particularly compact and easy to install. The special bearing can include a rolling bearing, preferably a ball bearing, roller bearing or similar, on the outside of which at least one sealing lip is molded. The inside of the bearing can be connected to the shaft. In this context, “injection-molded” can mean that the sealing lip is injection-molded into the rolling bearing using an injection molding process.

The feedthrough can be formed with a mounting surface and/or a seal that form-fits with the shaft. The form-fitting mounting surface ensures a particularly secure, torsion-resistant fit of the circular disk-shaped element on the shaft. The seal prevents the accumulation of dirt between the circular disk-shaped element and the shaft. The seal can be positioned further out on the shaft, i.e. towards the rotary plate, opposite the form-fitting mounting surface. It is conceivable that the form-fitting mounting surface forms a press fit or part of a clamping device for mounting the circular disk-shaped element to the shaft.

The circular disk-shaped element can comprise a protective collar for repelling dirt, which is designed, in particular as a cylinder segment concentric to the shaft, and which at least partially surrounds the sealing lip. This means that the shaft-sealing system can also be well protected against dirt penetrating laterally. For example, the protective collar can extend from an outer edge of the circular element towards the motor. In this context, the fact the concentric cylinder segment at least partially surrounds the sealing lip may mean that the concentric cylinder segment has a larger radius than the sealing lip, such that it is arranged radially within the protective collar.

The shaft can be connected to the rotary plate via a rotary plate adapter for adapting to different rotary plate types, which, in particular comprises a ring attachment facing away from the rotary plate for repelling dirt. This means that the container-handling machine can easily be adapted to different container types. Preferably, the rotary adapter can be arranged completely outside the motor housing or the bearing plate. The annular extension protects the shaft-sealing system even better from dirt. The annular extension of the rotary disk can preferably be used together with the protective collar of the circular disk-shaped element described above, which ensures particularly good protection of the shaft-sealing system. The annular extension can also be designed as a cylinder segment concentric to the shaft, which at least partially surrounds the shaft-sealing system.

The at least one sealing lip can be equipped with a supporting element for stabilization and/or with a tensioning element for applying a force against the running surface. Since the sealing lip is usually made of a flexible material, the support element can provide better stability, such that the sealing lip does not change its position relative to the running surface. The clamping element makes it possible to press the sealing lip against the running surface to ensure a reliable sealing effect. The clamping element can, for example, be a spring.

The shaft-sealing system may comprise a ring member having the first running surface, a second running surface and a feedthrough surrounding the shaft, at least one first sealing lip acting radially inwardly against the first running surface and a second sealing lip acting radially outwardly against the second running surface. As a result, the two sealing lips act radially against the respective running surface, whereby manufacturing tolerances of the motor and the shaft-sealing system in the vertical direction do not affect the reliability of the sealing effect and results in a scattering of the friction effect. In addition, this reduces the tolerances required for the installation of the shaft-sealing system.

Since no drive torque is transmitted with the ring element, the shaft can be particularly designed for transmitting the drive torque to the rotary plate, and the ring element can be particularly designed for the sealing effect. As a result, the shaft can be made of a softer material, since it no longer comes into contact with the sealing lip, and is therefore not subject to wear. Therefore, the one-piece shaft can be manufactured more easily. On the other hand, the ring element used to provide the sealing effect can be made of a special material suitable for this purpose, such as a hardened metal. The hardened metal can be a stainless steel with a hardness of 55-58 HRC and preferably ground without twisting. For example, 1.4034 (short name X46Cr13) or a comparable material can be used as the material for the ring element. The running surfaces can have a surface roughness of Ra=0.2 to 0.8 μm, Rz=1.0 to 4.0 μm and Rmax. 6.3 μm. This prevents high wear due to the sealing lips acting against the running surfaces, and the maintenance interval can be increased. Further costs can thus be saved when operating the rotary plate direct drive. In addition, the ring element can also be designed compactly with regard to the installation space, as it is not subject to fatigue due to the transmission of the drive torque. The feedthrough of the ring element can be cylindrical and/or form a mating surface for the shaft In other words, the ring element can be non-rotatably connected to the shaft via the feedthrough. It is conceivable that the feedthrough is designed as a clamping or fit, preferably as a press fit relative to the shaft. In this context, the “ring element” can mean that the first running surface and the second running surface are concentric to the feedthrough. Preferably, the ring element can be designed to be replaceable for maintenance or in the event of wear.

It is conceivable that the ring element has a preferably flat front side. The first running surface and the second running surface can protrude from the flat front side and/or be connected to each other via this flat front side. It is conceivable that the ring element is rotationally symmetrical to the shaft and has an essentially U-shaped profile.

The first running surface and the second running surface on the ring element can be designed as concentric cylinder surfaces for the feedthrough, between which the at least one first sealing lip and the second sealing lip are arranged. As a result, the manufacturing tolerances of the motor and the shaft-sealing system mentioned above have a particularly small effect on the sealing effect. Preferably, the first running surface or the second running surface designed as concentric cylinder surfaces can project vertically from the flat front side of the ring element, in particular vertically downwards. In this context, “vertical” can mean the direction pointing to the center of the earth. This prevents dirt particles from penetrating the shaft-sealing system from outside.

A third sealing lip can act radially inwards against the first running surface, particularly with a grease reservoir between the at least one first sealing lip and the third sealing lip. This further increases the sealing effect of the shaft-sealing system. In addition, a grease reservoir can be located between the at least one first sealing lip and the second sealing lip. The grease reservoir reduces wear on the sealing lips and the penetration of dirt particles.

The at least one first sealing lip, the second sealing lip and/or the third sealing lip may be integrally formed as a sealing ring and/or consist of a flexible material such as rubber. Preferably the at least one first sealing lip, the second sealing lip and the third sealing lip can protrude radially from a carrier ring.

Preferably the at least one first sealing lip, the second sealing lip, the third sealing lip and/or the sealing ring can be attached to the bearing plate and/or the housing of the motor. The bearing plate can comprise a conical deflecting surface arranged circumferentially on the shaft-sealing system, which drops off diagonally outwards, particularly in the profile. As a result, penetrating dirt particles are deflected outwards.

The rotary plate or rotary plate adapter can be fitted with a protective collar, preferably on the underside, to repel dirt. The bottom side of the protective collar can be arranged opposite the conical deflecting surface, such that a gap is formed for deflecting dirt particles.

Further features and advantages of the invention are explained in more detail below using the examples shown in the figures, thereby showing:

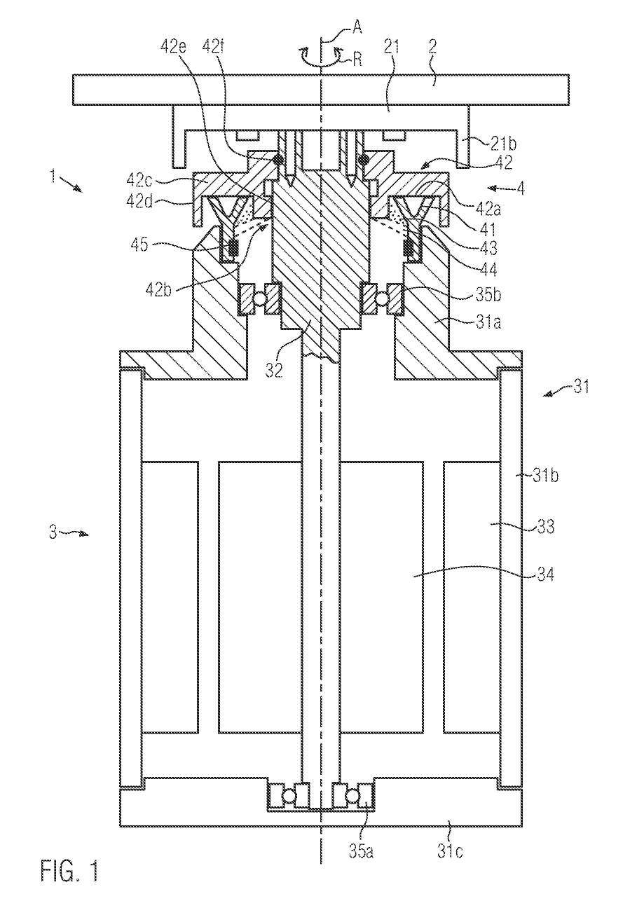

FIG. 1 an example of the rotary plate-direct drive with the shaft-sealing system in a side view;

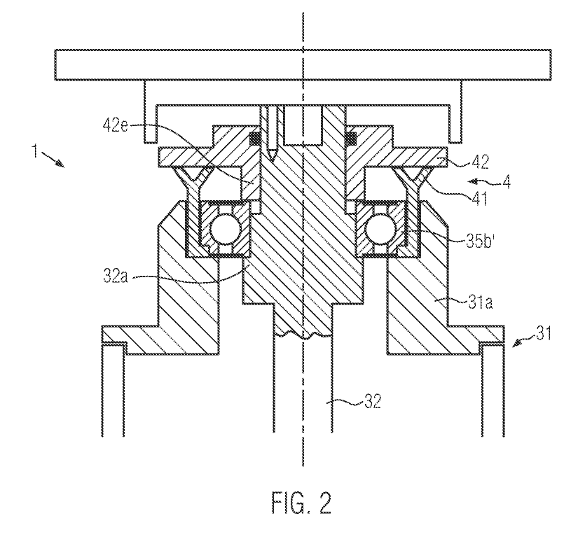

FIG. 2 another example of the shaft-sealing system in a lateral detailed view;

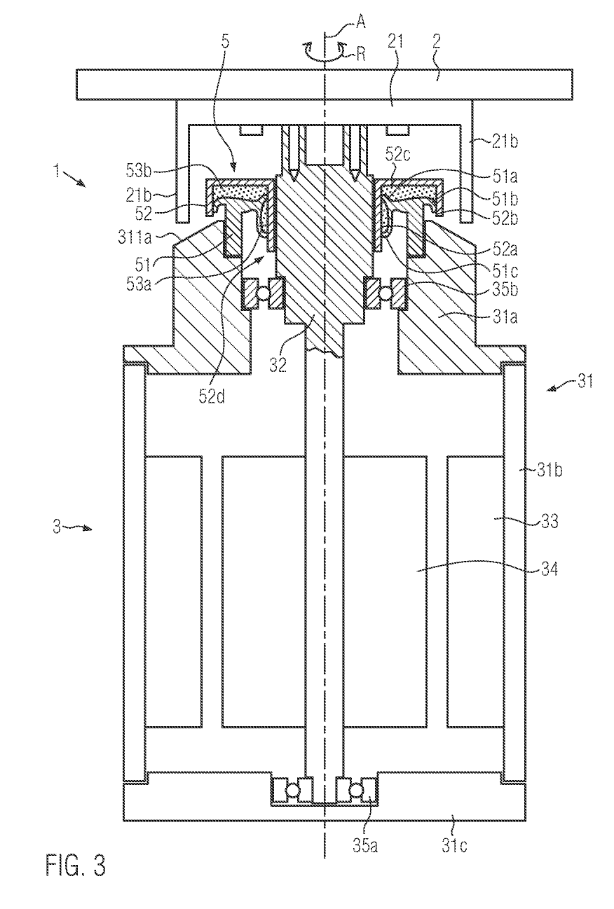

FIG. 3 a further example of the shaft-sealing system in a side view; and

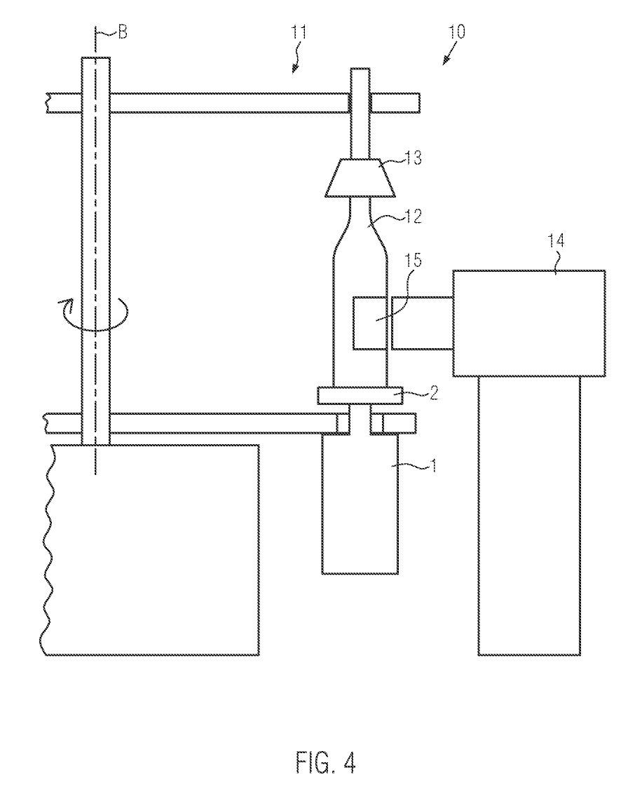

FIG. 4 an example of a container-handling machine with the rotary plate-direct drive according to FIG. 1, 2 or 3.

FIG. 1 shows an example of a direct rotary-plate drive 1 with the shaft-sealing system 4 in a side view. The direct drive 1 with the motor 3 can be seen, in whose housing 31 the stator 33 and the rotor 34 are located. Rotor 34 is non-rotatably fixed to the shaft 32, to the upper end of which the rotary plate 2 is fixed. The shaft 32 is designed to transmit the drive torque to the rotary plate 2 at least from the rotor 34 through the shaft-sealing system 4 in one piece. The shaft-sealing system 4 serves to protect the inner area of the motor 3 from penetrating dirt and/or moisture.

The motor housing 31 consists of a housing body 31b, which is hermetically sealed at the ends, with the bearing plate 31a (housing cover) on the one hand, and with the housing base 31c on the other. The shaft 32 is rotatably supported by the two ball bearings 35a and 35b in the bearing plate 31a and in the housing base 31c, respectively. To protect the motor from penetrating grease, the 35b ball bearing shown above can be designed as a deep groove ball bearing with two sealing washers. If necessary, the ball bearing 35a shown below can also be designed in this way. However, other suitable bearing types or position arrangements are also conceivable.

If a suitable alternating current is applied to the stator 33, which is generated from a direct current by a motor control (not shown here), the rotor 34 is set in motion by the electromagnetic forces, and thus the shaft 32 and the rotary plate 2 are rotated or swiveled about the drive axis A in the direction R. Here the motor is designed, for example, as a servomotor, and also comprises a rotary encoder, which is not shown in detail (e.g. Hall sensors or an optical or magnetic encoder). In this way, the desired angular position of the shaft 32 and thus of the rotary disk 2 can be precisely set via the motor control. Any type of electric motor (e.g. a DC, asynchronous or synchronous motor), which is operated with a closed control circuit, is conceivable. A stepper motor with or without a closed control circuit would also be conceivable.

The direct rotary plate-disk drive 1 shown in FIG. 1, for example, is located on the transport carousel of a container-handling machine, preferably a labelling machine, which is described in more detail below on the basis of FIG. 2. This allows containers to be rotated on the rotary plate 2 in the desired manner during labelling.

The rotary plate 2 comprises a circular plate, on the upper side of which the containers can be accommodated. It can also be seen that the shaft 32 is connected to the rotary plate 2 via the rotary plate adapter 21 for adapting to different rotary plate types. This makes rotary plate 2 particularly easy to replace. In addition, the annular extension 21b of the rotary plate adapter 21 is shown facing downwards, i.e. away from the rotary plate 2, as an option This protects the upper side of the shaft-sealing system 4 from dirt.

FIG. 1 also shows that motor 3 is sealed with the shaft-sealing system 4 in the area of the shaft feed-through to the rotary disk adapter 21. For this purpose, the sealing lip 41 arranged in the bearing plate 31a acts against the running surface 42a rotating with the shaft 32.

The shaft-sealing system 4 comprises the circular disk-shaped element 42 with the running surface 42a and with a feedthrough 42b enclosing the shaft 32. The fact that the circular disk-shaped element 42 is mounted as a ring on the shaft 32 separate from the bearing 35b via the feedthrough 42b, decouples it from the transmission of the drive torque. As a result, it is possible to manufacture the circular disk-shaped element 42 from a material suitable for the sealing effect and for low wear, for example, a hardened steel material. Since the circular disk-shaped element 4 is a turned part with a comparatively low mass, it can be manufactured particularly easily and economically.

On the other hand, a material can be used for the shaft 32, which is particularly easy to operate, as it is not subject to wear during operation due to the shaft-sealing system. In addition, the shaft 32 can be designed for optimum transmission of the drive torque.

It can also be seen that the shaft 32 between the rotor 34 and the rotary plate 2 is rotatably supported by the bearing 35b. On the other hand, the circular disk-shaped element 42 with its feedthrough 42b is connected to the shaft 32 opposite the bearing outside the rotary plate 2, such that it is decoupled from the bearing effect.

In addition, the feedthrough 42b is designed with the mounting surface 42e interlocking with the shaft as well as with a sealing ring 42f. The sealing ring 42f also prevents dirt from penetrating the motor 3. Thus, the interlocking mounting surface 42e forms a tight fit, such that a non-rotatable connection to the shaft 32 is established.

The running surface 42a is formed on a flat side of the circular disk-shaped element 42 on the disk body 42c, i.e. in the direction of the motor interior, facing away from the rotary plate 2. Consequently, the running surface 42a is arranged essentially perpendicular to the axis of rotation A. In contrast to the running surface 42a, two sealing lips 41 act in a Y-arrangement and form an axial shaft-sealing ring. As a result, the sealing lips 41 act essentially in the axial direction against the running surface 42a. It is also conceivable that there is a grease reservoir between the two sealing lips 41 in a Y-arrangement for greasing the shaft-sealing system 4.

In addition, the circular disk-shaped element 42 comprises a protective collar 42d facing away from the rotary plate 2 to repel dirt from the rotary plate 2 from the sealing area of sealing lip 41. The protective collar 42d is formed as a cylinder segment concentric to the shaft 32 surrounding the sealing lip 41. In other words, the protective collar 42d, which is designed as a concentric cylinder segment, has a slightly larger diameter than the sealing lips 41 and is cylindrical at the outer edge of the disk body 42c towards the shield 31a. As a result, penetrating dirt is deflected downwards. The protective collar 42d is optional and can therefore be omitted, as shown, for example, in FIG. 2.

The sealing lips 41 in the Y-arrangement are stabilized by the support element 45 and held in the bearing plate 31a. The sealing lips 41 are also removable from the bearing plate 31a for replacement. The sealing lips 41 are preferably contained in a sealing cartridge, which can be detachably connected to the bearing plate 31a.

It is also conceivable that the Y-arrangement of the sealing lips 41 is modified to include only one sealing lip. This is then preferably directed diagonally upwards and outwards relative to the drive axis A, such that the dirt is deflected outwards of the sealing lip.

In addition, a further internal sealing lip 44 with a grease reservoir of 43 for greasing the shaft-sealing system 4 can optionally be arranged on the Y-arrangement of the sealing lips 41. In addition, the middle sealing lip between the sealing lips 41 and 44 can also be completely omitted. Also, only the sealing lip 41 can be arranged. It would then be possible to arrange the grease reservoir in the resulting interior space for greasing the shaft-sealing system.

The sealing system 4 shown in FIG. 1 makes it possible to decouple the sealing effect from the bearing effect or the transmission of the drive torque. This makes it possible to use particularly suitable materials and manufacture the elements cost-effectively. In addition, installation space can be saved by means of the thinner design of the shaft 32.

FIG. 2 shows another design example of the shaft-sealing system 4 in a detailed side view. It differs from the example in FIG. 1 only in that a special bearing 35b′ is used, in which the sealing lips 41 are injection-molded onto the rolling bearing. The bearing plate 31a is therefore designed with a cylindrical fitting surface, such that the outside of the special bearing 35b′ can be mounted in it. It can also be seen that the special bearing 35b′ is clamped on the inside between the edge 32a of the shaft 32 and the circular disk-shaped element 42, preferably with the lower end of the interlocking mounting surface 42e. Consequently, the special bearing 35b′ can be easily detached from the shaft 32 and replaced.

The special bearing 5b′ shown in FIG. 2 makes the shaft-sealing system 4 particularly compact and easy to install.

FIG. 2 also shows that the circular disk-shaped element 42 is designed without a protective collar. As an option, however, it can also be present, as in FIG. 1.

FIG. 3 also shows another example of the design of the shaft-sealing system 5 in a lateral view. The example in FIG. 3 differs from that in FIG. 1 essentially in the structure of the shaft-sealing system 5. All other features apply accordingly.

It can be seen that the motor 3 is sealed in the area of the shaft feedthrough towards the rotary plate adapter 21 with the shaft-sealing system 5. For this purpose, the first and third sealing lips 51a and 51c arranged in the bearing plate 31a act radially inwards against the first running surface 52a connected to the shaft 32 and the second sealing lip 51b radially outwards against the second running surface 52b connected to the shaft 32.

The shaft-sealing system 5 comprises the sealing ring 51 with the first, second and third sealing lip 51a, 51b, 51c and the ring element 52 with the first and second running surface 52a, 52b. The shaft-sealing system 5 can also be designed as a replaceable sealing cartridge.

It can be seen that the first sealing lip 51a, the second sealing lip 51b and the third sealing lip 51c are formed in one piece as sealing ring 51 and protrude from a carrier ring. To ensure a particularly good sealing effect, the sealing lips 51a, 51b and 51c are made of a flexible material, such as rubber. It is also conceivable here that the sealing ring 51, similar to FIG. 1, is provided with a supporting element for stabilization.

The ring element 52 is designed with the first running surface 52a, the second running surface 52b and with a feedthrough 52d enclosing the shaft 32. The fact that the ring element 52 is mounted on the shaft 32 separately from the bearing 35b via the feedthrough 52d as a ring, decouples it from the transmission of the drive torque. This makes it possible to manufacture the ring element 52 from a material suitable for the sealing effect and for low wear, for example, a hardened steel material. On the other hand, a material can be used for the shaft 32 that is particularly easy to operate, since it is not subject to wear during operation due to the shaft-sealing system 5. In addition, the shaft 32 can be designed for optimum transmission of the drive torque.

In addition, the feedthrough 52d is designed with a mounting surface that form-fits with the shaft. Thus, the form-fitting mounting surface forms a tight fit so that a non-rotatable connection to the shaft 32 is established.

The first running surface 52a and the second running surface 52b are formed on the ring element 52 as cylindrical surfaces that is concentric to the feedthrough 52d, between which the first sealing lip 51a, the second sealing lip 51b and the third sealing lip 51c are arranged. In other words, the first running surface 52a and the second running surface 52b form an annular gap, into which the sealing lip 51a, 51b and 51c protrude.

In addition, the ring element 52 comprises the front side 52c, from which the first running surface 52a and the second running surface 52b protrude vertically downwards. The front side 52c here is circular disk-shaped or flat. However, it is also conceivable that the front side 52c has a curvature in the profile.

To reduce wear on sealing lips 51a, 51b and 51c, there are grease reservoirs 53a, 53b between the first sealing lip 51a and the third sealing lip 51c and between the first sealing lip 51a and the second sealing lip 51b. As a result, dirt particles are prevented from penetrating the shaft-sealing system 5 into the interior of motor 3.

It can also be seen that the shaft 32 between the rotor 34 and the rotary plate 2 is rotatably supported by the bearing 35b. On the other hand, the ring element 52 with its feedthrough 52d is arranged outside towards the rotary plate 2 and connected to the shaft 32, such that it is decoupled from the bearing effect.

The bearing plate 31a comprises the conical deflecting surface 311a, which is arranged circumferentially on the shaft-sealing system 5 and which drops diagonally outwards in the profile. This allows any penetrating dirt particles to be deflected outwards.

In addition, the rotary plate adapter 21 comprises a protective collar 21b, preferably arranged on the underside, for repelling dirt. The bottom side of the protective collar 21b is arranged opposite the conical deflecting surface 311a, such that a gap is formed for deflecting dirt particles. In addition, particularly few dirt particles can penetrate from the outside to the shaft-sealing system 5 through the gap designed in this way.

Since the sealing lips 51a, 51b and 51c act radially inwards and outwards respectively against the first running surface 52a and the second running surface 52b, respectively, tolerances of the rotary disk direct drive 1, in particular of the sealing system 5 and of the motor 3 in vertical direction do not result in an unreliable sealing effect or scattering of the friction effect. In addition, this reduces the requirements on tolerances when installing the shaft-sealing system 5.

The sealing system 5 shown in FIG. 3 also makes it possible to decouple the sealing effect from the bearing effect or transmission of the drive torque. This makes it possible to use particularly suitable materials and to manufacture the elements cost-effectively. In addition, installation space can be saved by means of the thinner design of the shaft 32.

FIG. 4 shows an example of a container-handling machine 10 in a side view, which is designed here as a labelling machine. The transport carousel 11 with the circumferentially arranged rotary plates 2 can be seen, each with a rotary plate-direct drive 1. These can form the container holders for themselves or together with the centring bells 13. For the sake of clarity, only a rotary plate 2 with a direct drive 1 is shown here, but there is a large number of such arrangements at regular angular spacings around the transport carousel 11. The transport carousel 11 rotates around its carousel axis B by means of a drive, which is not shown in detail here.

During operation, the containers 12 are clamped with the rotary plate 2 and/or the centring bell 13 and conveyed through the labelling station 14. During labelling, they are rotated in a defined manner by means of the direct drive 1, such that the label 15 is applied as evenly as possible to the circumference of the container.

With the direct drive 1, the dirt penetrating from above and from the side is deflected outwards with a sealing system 4, 5 in accordance with the examples in FIG. 1, 2 or 3, such that the inner structure of the direct rotary disk drive 1 is not damaged.

It goes without saying that the features mentioned in the design examples described above are not limited to these particular combinations and are possible in any other combinations.

1. A container-handling machine having at least one container receiving means, comprising:
a rotary plate and a rotary plate-direct drive for driving the rotary plate, the rotary plate direct drive comprising a motor which is provided with a stator, a rotor, a shaft connected to the rotor for transmitting the driving torque to the rotary plate and with a shaft-sealing system for sealing the shaft, wherein the shaft-sealing system comprises a first running surface and at least one sealing lip acting against the first running surface,
wherein
the shaft is formed in one piece at least from the rotor and through the shaft-sealing system, and
the running surface is rotatably connected to the shaft from the transmission of the driving torque in a decoupled manner.

2. The container-handling machine according to claim 1, wherein the shaft-sealing system comprises a circular disk-shaped element with the running surface and a feedthrough enclosing the shaft, wherein the circular disk-shaped element forms a connection between the shaft and the running surface, decoupled from the transmission of the drive torque, between the shaft and the running surface.

3. The container-handling machine according to claim 2, wherein the shaft is rotatably supported with at least one bearing between the rotor and the rotary plate, and wherein the circular disk-shaped element is decoupled from a bearing effect of the bearing on the shaft.

4. The container-handling machine according to claim 2, wherein the running surface is formed on a flat side of the circular disk-shaped element remote from the rotary plate, and wherein the at least one sealing lip is designed as an axial shaft-sealing ring.

5. The container-handling machine according to claim 2, wherein the at least one sealing lip includes two sealing lips in a Y-arrangement act against the running surface of the circular disk-shaped element.

6. The container-handling machine according to claim 5, wherein the Y-arrangement of the two sealing lips comprises a further internal sealing lip and a grease reservoir.

7. The container-handling machine according to claim 1, wherein the shaft-sealing system comprises a special bearing, to which the at least one sealing lip is attached.

8. The container-handling machine according to the claim 2, wherein the feed-through is formed with a mounting surface and/or a seal that form-fits with the shaft.

9. The container-handling machine according to claim 2, wherein the circular disk-shaped element comprises a protective collar for repelling dirt which is remote from the rotary plate.

10. The container-handling machine according to claim 1, the shaft being connected to the rotary plate via a rotary plate adapter for adapting different rotary plate types.

11. The container-handling machine according to claim 1, wherein the at least one sealing lip is formed with a supporting element for stabilization and/or with a clamping element for applying a force against the running surface.

12. The container-handling machine according to claim 1, wherein the at least one sealing lip is attached to a bearing plate and/or a housing of the motor.

13. The container-handling machine according to claim 1, wherein the shaft-sealing system comprises a ring element with the first running surface, a second running surface, and with a feedthrough enclosing the shaft, and wherein the at least one sealing lip includes a first sealing lip that acts radially inwardly directed against the first running surface and a second sealing lip that acts radially outwardly directed against the second running surface.

14. The container-handling machine according to claim 13, wherein the first running surface and the second running surface on the ring element are formed as cylinder surfaces concentric with the feedthrough, between which the first sealing lip and the second sealing lip are arranged.

15. The container-handling machine according to claim 13, wherein the at least one sealing lip includes a third sealing lip acting radially inwards against the first running surface.

16. The container-handling machine according to the claim 13, wherein a grease reservoir is located between the first sealing lip and the second sealing lip.

17. The container-handling machine to according to claim 7, wherein the at least one sealing lip is injection-molded.

18. The container-handling machine according to claim 9, where the protective collar is a cylinder segment that is concentric with the shaft and that at least partially surrounds the sealing lip.

19. The container-handling machine according to claim 10, wherein the rotary plate comprises an annular extension facing away from the rotary plate for repelling dirt.

20. The container-handling machine according to claim 15, wherein a grease reservoir is located between the first sealing lip and the third sealing lip.
